(19) United States
(12) Patent Application Publication
(10) Pub. No.: US 2012/0181723 A1
(43) Pub. Date: Jul. 19, 2012

(54) METHOD OF PRODUCING PLASTIC STAMP

(76) Inventors: Ikuzo MATSUSHITA, Nara (JP); Yoshiaki NAGATA, Osaka (JP); Katsuya TAKAICHI, Nara (JP)

(21) Appl. No.: 13/080,953

(22) Filed: Apr. 6, 2011

(30) Foreign Application Priority Data
Jan. 19, 2011 (JP) 2011-008896

(51) Int. Cl. B29C 33/42

(52) U.S. Cl. 264/219

(57) ABSTRACT

A method of producing a plastic stamp includes the steps of mixing a thermoplastic resin and a cross-linking agent to obtain a molding material; placing the molding material in a molding die; and performing a direct pressure molding at 160° C. to 190° C. for 5 to 10 minutes for performing a cross-linking reaction to produce the plastic stamp.

### BACKGROUND OF THE INVENTION AND RELATED ART STATEMENT

The present invention relates to a method of producing a plastic stamp or a synthetic resin stamp having a seal face formed through a casting process or a laser engraving process.

Patent Reference has disclosed a conventional plastic stamp. The conventional plastic stamp is formed of a rubber, and has a seal face formed through a casting process or an engraving process.
Patent Reference Japanese Patent Publication No. 06-239046

When a rubber raw material is burned in a process such as a casting process of the seal face of the conventional plastic stamp, the casting process tends to generate a large amount of oil smoke or an environmental hazardous material such as sulfur oxide (originated from a vulcanization agent) or nitride oxide (originated from a vulcanization promoter agent). Further, it is necessary to store the rubber raw material in a refrigerated condition. Further, when the seal face is produced through a laser engraving process, strong odor tends to generate, thereby causing an environmental problem.

In view of the problems described above, an object of the present invention is to provide a method of producing a plastic stamp capable of solving the problems of the conventional plastic stamp. In the present invention, it is possible to store a raw material at a normal room temperature. Further, when a seal face of the plastic stamp is produced through a laser engraving process, it is possible to prevent strong odor from generating.

Further objects of the invention will be apparent from the following description of the invention.

### SUMMARY OF THE INVENTION

In order to attain the object described above, according to the present invention, a method of producing a plastic stamp includes the steps of mixing a thermoplastic resin and a cross-linking agent to obtain a molding material; placing the molding material in a molding die; and performing a direct pressure molding at 160° C. to 190° C. for 5 to 10 minutes for performing a cross-linking reaction to produce the plastic stamp.

In the present invention, when the thermoplastic as a raw material is burned in a process such as casting a seal face of the plastic stamp, it is possible to reduce an amount of oil smoke as opposed to the conventional plastic stamp. Further, as opposed to a rubber raw material of the conventional plastic stamp, the thermoplastic does not contain a vulcanization agent or a vulcanization promoter agent. Accordingly, when the thermoplastic is burned, an environmental hazardous material such as sulfur oxide or nitride oxide is not generated. Still further, when the seal face is produced through a laser engraving process, strong odor is not generated.

### BRIEF DESCRIPTION OF THE DRAWINGS

FIG. 1 is a process chart showing a method of producing a plastic stamp according to an embodiment of the present invention.

### DETAILED DESCRIPTION OF PREFERRED EMBODIMENTS

Hereunder, embodiments of the present invention will be hereinafter described with reference to the drawing.

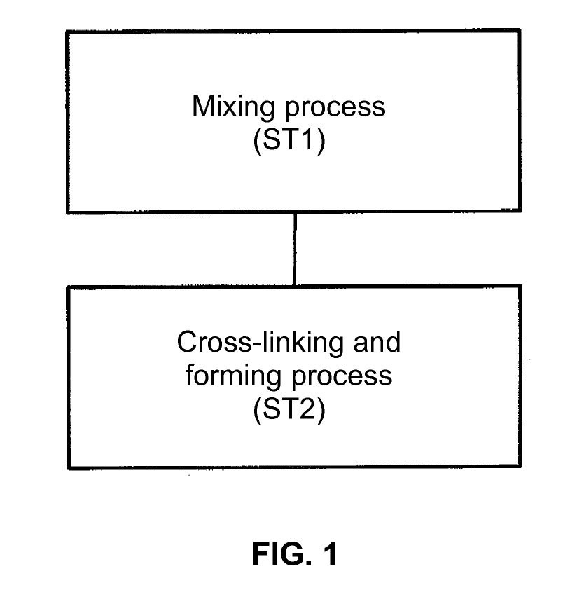

A method of producing a plastic stamp will be explained with reference to FIG. 1. In the embodiment, a seal face of the plastic stamp is formed through a casting process or an engraving process.

As shown in FIG. 1, the method of producing the plastic stamp includes a mixing process ST1 and a cross-linking and forming process ST2. In the mixing process ST1, a thermoplastic resin is mixed with a cross-linking agent formed of an organic peroxide to obtain a molding material. In the cross-linking and forming process ST2, the molding material is placed or injected into a molding die. Then, a direct pressure molding is performed at 160° C. to 190° C. for 5 to 10 minutes, so that a cross-linking reaction is progressed.

In the present embodiment, the thermoplastic resin is preferably capable of cross-linking with the cross-linking agent formed of an organic peroxide. The thermoplastic resin may include polyethylene, polypropylene, an ethylene-vinyl acetate copolymer, polystyrene, poly acrylate, poly methyl acrylate, poly acrylic amide, poly methyl vinyl ether, poly methyl vinyl ketone, a poly butadiene resin, and a thermoplastic elastomer.

In the embodiment, the thermoplastic resin preferably has a mixing process temperature less than 150° C., and a hardness less than 80 points measured with a type A durometer according to JIS K6253. In view of the requirements, the thermoplastic resin preferably includes an ethylene vinyl acetate copolymer, ultra low density polyethylene, and a thermoplastic elastomer such as a polystyrene vinyl iso-propylene tri-block copolymer and a poly butadiene resin.

In the present embodiment, the cross-linking agent is capable of cross-linking at least the thermoplastic resin to be used. The cross-linking agent capable of cross-linking a synthetic resin includes a dialkylperoxide type cross-linking agent, a peroxy ketal type cross-linking agent, a hydroperoxide type cross-linking agent, a peroxy ester type cross-linking agent, and the like. The cross-linking agent preferably has a high decomposition temperature, so that the cross-linking agent can be heated approximately to 130° C. to 150° C. in a process of kneading the molding material.

When the cross-linking agent has an excessively high decomposition temperature, it takes a longer time for the cross-linking. On the other hand, when the cross-linking agent has an excessively low decomposition temperature, the cross-linking agent may start to decompose during the process of kneading, thereby making it difficult to obtain a good molded material. Therefore, it is preferred that the maximum kneading temperature is 100° C. or less and the cross-linking agent has a standard cross-linking temperature approximately of 160° C. to 180° C. Accordingly, the cross-linking agent is preferably selected from dialkylperoxides.

In the present embodiment, in addition to the thermoplastic elastomer, the thermoplastic resin, and the cross-linking agent, the molding material may contain a plasticizing agent, mineral oil, a surface activating agent, a pigment, a thermal stabilizer, a lubricant, an ultraviolet absorbing agent, an antistatic agent, a fire retarding material, or an anti-aging agent. It is preferred that such an additive is added with 50 parts by weight or less with respect to 100 parts by weight of the thermoplastic synthetic resin.

In the embodiment, when the thermoplastic elastomer and ultra low density polyethylene are used in the mixing and dispersing process ST1, it is preferred that 10 to 100 weight parts of ultra low density polyethylene is mixed with 100 weight parts of the thermoplastic elastomer. When more than 100 weight parts of ultra low density polyethylene is mixed, the molded material tends to exhibit greater hardness, thereby making it difficult to form a quality stamped seal.

In the embodiment, a ratio of the cross-linking agent is preferably in a range from one to five parts by weight, more preferably in a range from one to two parts by weight, relative to 100 parts by weight of the thermoplastic synthetic resin.

In the mixing and dispersing process ST1 according to the present embodiment, the molding material is obtained through blending and mixing uniformly the thermoplastic resin composition, and the cross-linking agent, in addition to the additives if necessary. In the mixing and dispersing process ST1, an open roll mill, a heat/pressure kneader, an intensive mixer, a single spindle extruder, a double spindle extruder, an internal mixer, a co-kneader, or a continuous kneading machine with double spindle rotor may be arbitrarily used.

In the cross-linking and forming process ST2 according to the present embodiment, the molding material obtained in the mixing and dispersing process ST1 is filled in a molding die having a cavity corresponding to a shape of the stamp face. Then, a direct pressure molding (referred to as a compression molding or a heat press molding) is performed under a specific condition (described later), so that a cross-linking reaction and a shape forming of the seal face are performed coincidentally.

In the embodiment, a temperature for the cross-linking reaction and the shape forming is in a range from 150° C. to 190° C., at which the thermoplastic synthetic resin composition melts thereby to soften and the cross-linking agent decomposes to produce a cross-linked material. A time duration for the cross-linking and the shape forming is in a range from four to 10 minutes with the inclusion of preheating, air evacuating and gas evacuating.

In the embodiment, when the temperature for the cross-linking and the shape forming exceeds 190° C., the cross-linking reaction progresses too fast. In this case, the cross-linking reaction excessively progresses in the preheating stage, thereby making it difficult to obtain a high-quality molded material. On the contrary, when the temperature for the cross-linking and forming is lower than 150° C., the cross-linking reaction may not sufficiently complete. In this case, void may be generated in the molded material, or it may be difficult to remove a portion of the molded material from the molding die, thereby making it difficult to obtain a high-quality molded material. When the time duration for the cross-linking and forming is shorter than four minutes, the cross-linking reaction may not complete, thereby making it difficult to obtain a high-quality molded material. On the other hand, when the time duration for the cross-linking and forming exceeds ten minutes, the productivity becomes lower, thereby increasing a cost of the product.

In the cross-linking and forming process ST2, the molding die includes a metal molding die made of aluminum, iron or the like, or a synthetic resin molding die made of phenol resin, ebonite or the like. When the metal molding die is made of copper or an alloy thereof such as brass, copper tends to inhibit the cross-linking reaction, so that the metal molding die may not be suitable. According to the present embodiment, the molding die is formed with a pattern in accordance with characters, figures or designs of the stamp face, thereby forming the stamp face. Accordingly, it is unnecessary to perform an additional engraving process.

In the cross-linking and forming process ST2, a direct pressure molding machine includes a heat press machine to be usually used for cross-linking a rubber, and a pressing capability thereof may be approximately within a range from 10 to 50 tons. While it is enough to heat up to approximately 200° C., an accurate temperature control is required.

In the cross-linking and forming process ST2, after pre-heating the molding die to be used to a molding temperature, the molding material in a pellet-form is uniformly filled in the molding die. Then, the molding material is molded to obtain the molded material under the pressing and heating condition for four to 10 minutes through pre-heating, pressing, air evacuating and gas evacuating in this order.

In the embodiment, the molded material is removed from the molding die after being cooled down for 30 to 60 seconds to a range from 30° C. to 50° C. of a surface temperature thereof. Accordingly, it is enabled to stabilize a shape of the molded material by releasing the same from the molding die after cooling down below the melting point. Further, after the molded material with a flat main surface is obtained, the main surface may be engraved with a laser to form an undulated shape corresponding to the seal face of the plastic stamp through a laser engraving process.

An experiment for evaluating the plastic stamp will be explained next. In the evaluation, examples No. 1 to No. 3 were prepared as follows.

In preparing the example No. 1, 70 parts by weight of the thermoplastic elastomer, 30 parts by weight of ultra low density polyethylene, 2 parts by weight of the cross-linking agent, and 0.025 part by weight of a red organic pigment were mixed for five minutes using a drum tumbler, thereby obtaining a uniform mixture. The mixture was kneaded using a twin screw extruder, thereby obtaining a molding material of the example No. 1.

In preparing the example No. 2, similar to the example No. 1, 30 parts by weight of the thermoplastic elastomer, 70 parts by weight of ultra low density polyethylene, 2 parts by weight of the cross-linking agent, and 0.025 part by weight of a red organic pigment were mixed for five minutes using a drum tumbler, thereby obtaining a uniform mixture. The mixture was kneaded using a twin screw extruder, thereby obtaining a molding material of the example No. 2.

In preparing the example No. 3, similar to the example No. 1, 50 parts by weight of an ethylene vinyl acetate copolymer, 50 parts by weight of ethylene vinyl acetate, 2 parts by weight of the cross-linking agent, and 0.025 part by weight of a red organic pigment were mixed for five minutes using a drum tumbler, thereby obtaining a uniform mixture. The mixture was kneaded using a twin screw extruder, thereby obtaining a molding material of the example No. 3.

In the next step, the molding materials of the examples No. 1 to No. 3 were molded under the following conditions. First, after a resin molding die was pre-heated to 160° C., 50 grams of the molding material was uniformly placed on the resin molding die. Then, the resin molding die was preliminarily heated for 20 seconds. Afterward, the resin molding die was placed in a direct pressure molding machine, so that a pressure was applied to the resin molding die for degassing for four to five times.

In the next step, a pressure of 50 kg/cm² was applied to the resin molding die. After four minutes, the degassing was repeated for two times. After five minutes, the resin molding die was removed from the direct pressure molding machine. After the resin molding die was naturally cooled for sixty seconds, the molding material was removed from the resin molding die, thereby obtaining a molded part. It is noted that the molding temperature and the molding time were set as an optimum condition in accordance with a size and a design of the resin molding.

In order to evaluate stamp ability, a plastic stamp was prepared using each of the molding materials of the examples No. 1 to No. 3. Then, the plastic stamp was evaluated using a stamp pad (HGN-2, a black pigment type, a product of Shachihata Inc.). As a result of the evaluation, although an appearance was substantially identical, it was found that the plastic stamp using the molding material of the example No. 2 showed inferior result as compared with those using the molding materials of the examples No. 1 and No. 3. Accordingly, the plastic stamps using the molding materials of the examples No. 1 and No. 3 were further evaluated.

In order to evaluate organic solvent resistance of the plastic stamp, a solvent generally used in a stamp pad was selected. A commercially available stamp pad includes a non-absorption face stamp pad (a metal, a plastic, glass, leather, a cloth, and the like).

In the evaluation, the solvent may include a glycol ether type solvent such as ethylene glycol mono-methyl ether, ethylene glycol mono-ethyl ether, and ethylene glycol mono-propyl ether; a diol type solvent such as ethylene glycol, propylene glycol, and 2-methyl 2,4-pentane dicol; an ester type solvent such as polypropylene glycol monoricirate; and an alcohol type solvent such as methanol, ethanol, isopropyl alcohol (IPA), butanol, 3-methoxy 1-butanol.

In the evaluation, dipropylene glycol mono-methyl ether and 3-methoxy 1-butanol were selected as one of most commercially available solvents. The plastic stamp was immersed in dipropylene glycol mono-methyl ether and 3-methoxy 1-butanol for 30 days. After the immersion, the plastic stamps using the molding materials of the examples No. 1 and No. 3 did not exhibit any problem.

In order to evaluate combustion property, the molding materials of the examples No. 1 and No. 3 were burned, and compared with a rubber material. Then, an extent of oil smoke was visually evaluated. As a result of the evaluation, all of the materials generated oil smoke. However, the rubber material generated oil smoke several times more than the molding materials of the examples No. 1 and No. 3.

In general, a rubber material is known to contain sulfur and a nitrogen compound. Accordingly, when the rubber material is burned, sulfuric oxide and nitric oxide are generated, thereby causing strong odor. On the other hand, the molding materials of the examples No. 1 and No. 3 do not contain sulfur and a nitrogen compound. Accordingly, when the molding materials of the examples No. 1 and No. 3 are burned, sulfuric oxide and nitric oxide are not generated, thereby causing little odor.

In order to evaluate storage property, the molding materials of the examples No. 1 and No. 3 were placed under a room temperature for six months. Afterward, the molding materials of the examples No. 1 and No. 3 were placed in the resin molding die, and were cross-linked at 160° C. for six minutes with the direct pressure molding machine. As a result, it was possible to obtain a molded part with good quality. In general, it is necessary to store a rubber material under a refrigerated condition. On the other hand, it is possible to store the molding materials of the examples No. 1 and No. 3 under a room temperature.

In order to evaluate engraving property, the molding materials of the examples No. 1 and No. 3 were placed in an aluminum molding die having a thickness of 3 mm and a size of 100 mm square. Then, the molding materials of the examples No. 1 and No. 3 were pressed and molded at 170° C. for six minutes. Then, a molded part was engraved with a laser. As a result, it was possible to obtain an engraved part with good quality.

The disclosure of Japanese Patent Application No. 2011-008896, filed on Jan. 19, 2011 is incorporated in the application by reference.

While the invention has been explained with reference to the specific embodiments of the invention, the explanation is illustrative and the invention is limited only by the appended claims.

What is claimed is:

1. A method of producing a plastic stamp, comprising the steps of:
mixing a thermoplastic resin and a cross-linking agent to obtain a molding material;
placing the molding material in a molding die; and
performing a direct pressure molding at 160° C. to 190° C. for 5 to 10 minutes for performing a cross-linking reaction to produce the plastic stamp.

2. The method of producing the plastic stamp according to claim 1, wherein, in the step of placing the molding material in the molding die, said molding die has an undulated surface corresponding to a seal face of the plastic stamp so that the seal face is formed in the step of performing the direct pressure molding.

3. The method of producing the plastic stamp according to claim 1, further comprising the step of engraving a surface of the plastic stamp with a laser to form a seal face.

4. The method of producing a plastic stamp according to claim 1, wherein, in the step of mixing the thermoplastic resin and the cross-linking agent, said thermoplastic resin includes at least one of polyethylene, polypropylene, an ethylene-vinyl acetate copolymer, polystyrene, poly acrylate, poly methyl acrylate, poly acrylic amide, poly methyl vinyl ether, poly methyl vinyl ketone, a poly butadiene resin, and a thermoplastic elastomer.

5. The method of producing a plastic stamp according to claim 1, wherein, in the step of mixing the thermoplastic resin and the cross-linking agent, said cross-linking agent includes at least one of a dialkylperoxide type cross-linking agent, a peroxy ketal type cross-linking agent, a hydroperoxide type cross-linking agent, and a peroxy ester type cross-linking agent.

6. The method of producing a plastic stamp according to claim 1, wherein, in the step of mixing the thermoplastic resin and the cross-linking agent, said thermoplastic resin includes at least one of an ethylene vinyl acetate copolymer, ultra low density polyethylene, and a polystyrene vinyl iso-propylene tri-block copolymer.

7. The method of producing a plastic stamp according to claim 1, wherein, in the step of mixing the thermoplastic resin and the cross-linking agent, said cross-linking agent includes dialkylperoxide.

8. The method of producing a plastic stamp according to claim 1, wherein, in the step of mixing the thermoplastic resin and the cross-linking agent, said thermoplastic resin is formed of ultra low density polyethylene and a thermoplastic elastomer.

9. The method of producing a plastic stamp according to claim 1, wherein, in the step of mixing the thermoplastic resin and the cross-linking agent, said thermoplastic resin is formed of 10 to 100 weight parts of ultra low density polyethylene and 100 weight parts of a thermoplastic elastomer.
